(19) United States
(12) Patent Application Publication
(10) Pub. No.: US 2019/0057202 A1
(43) Pub. Date: Feb. 21, 2019

(54) METHODS AND SYSTEMS FOR CAPTURING BIOMETRIC DATA

(71) Applicant: Daon Holdings Limited, George Town (KY)

(72) Inventor: Adria PEREZ-ROVIRA, Dublin (IE)

(21) Appl. No.: 15/678,314

(22) Filed: Aug. 16, 2017

(51) Int. Cl. G06F 21/32; G06K 9/00; H04M 1/14

(52) U.S. Cl. CPC G06F 21/32; H04M 1/14; G06K 9/00892

(57) ABSTRACT

A method for capturing biometric data is provided that includes causing, by a vibration engine included in a computing device, the computing device to vibrate. Moreover, the method includes detecting, by the computing device, movement of the computing device where the movement represents dampened computing device vibrations and capturing, by the computing device, data regarding the movement.

### BACKGROUND OF THE INVENTION

This invention relates generally to authentication transactions, and more particularly, to methods and systems for capturing biometric data.

People are typically required to prove their identity to access secure resources and to conduct many types of network-based transactions. Resources known to be accessed include computer systems, applications stored on computer systems and/or smart devices, ATM machines, secure buildings and/or sites, and secure electronic data. Network-based transactions known to be conducted include making a purchase from an on-line merchant and accessing bank accounts via the Internet.

Known methods for proving identity are based on what people know, for example, username, password, and personal identification number (PIN), and what they have, for example, a smart card or a fob. However, it is common for people to need many different usernames, passwords, and PINs which can be difficult to remember. To help remember, people have been known to write their identification data somewhere. Unfortunately, imposters have been known to obtain identification data by finding the written versions or by spying on people entering their identification data. Imposters typically use the stolen identification data to fraudulently access resources and/or to conduct fraudulent network-based transactions. For example, imposters have been known to use stolen identification data to unlock smart devices and steel applications and other data stored therein. Thus, identification data like usernames, passwords, and PINs, may be easily compromised resulting in extreme inconvenience for individuals and increased costs for on-line merchants and other entities responsible for maintaining security.

It is typically more difficult for imposters to use smart cards and fobs to conduct fraudulent transactions because smart cards and fobs are used in conjunction with a PIN. However, as discussed above, imposters have also been known to obtain PINs. Consequently, lost or stolen smart cards and fobs also present a security problem for on-line merchants and other entities conducting business or operations over the Internet. Moreover, losing a smart card or fob is inconvenient for users and replacing them is known to be time consuming and expensive for on-line merchants and other entities interested in maintaining a high level of security for Internet based operations.

### BRIEF DESCRIPTION OF THE INVENTION

In one aspect, a method for capturing biometric data is provided that includes causing, by a vibration engine included in a computing device, the computing device to vibrate. Moreover, the method includes detecting, by the computing device, movement of the computing device where the movement represents dampened computing device vibrations, and capturing, by the computing device, data regarding the movement.

In another aspect, a computing device for capturing biometric data is provided that includes a processor and a memory. The memory is configured to store data. The computing device is associated with a network and the memory is in communication with the processor. The memory has instructions stored thereon which, when executed by the processor, cause the computing device to vibrate and detect movement of the computing device wherein the movement represents dampened computing device vibrations. Moreover, the instructions when executed by the processor cause the computing device to capture data regarding the movement.

In yet another aspect, a method for determining user liveness is provided that includes causing, by a vibration engine included in a computing device, the computing device to vibrate. Moreover, the method includes detecting, by the computing device, dampened computing device vibrations, creating a biometric template from the dampened vibrations and matching the created template against a corresponding user record template. Furthermore, the method includes calculating a matching score based on the match and determining, by the computing device, the user is live when the matching score is at least equal to a threshold score.

### BRIEF DESCRIPTION OF THE DRAWINGS

FIG. 1 is a side view of a person holding an example computing device;

FIG. 2 is a block diagram of the example computing device illustrated in FIG. 1;

FIG. 3 is a flowchart illustrating an example method for capturing biometric data from a user; and

FIG. 4 is a flowchart illustrating an example method for verifying the identity of a user.

### DETAILED DESCRIPTION OF THE INVENTION

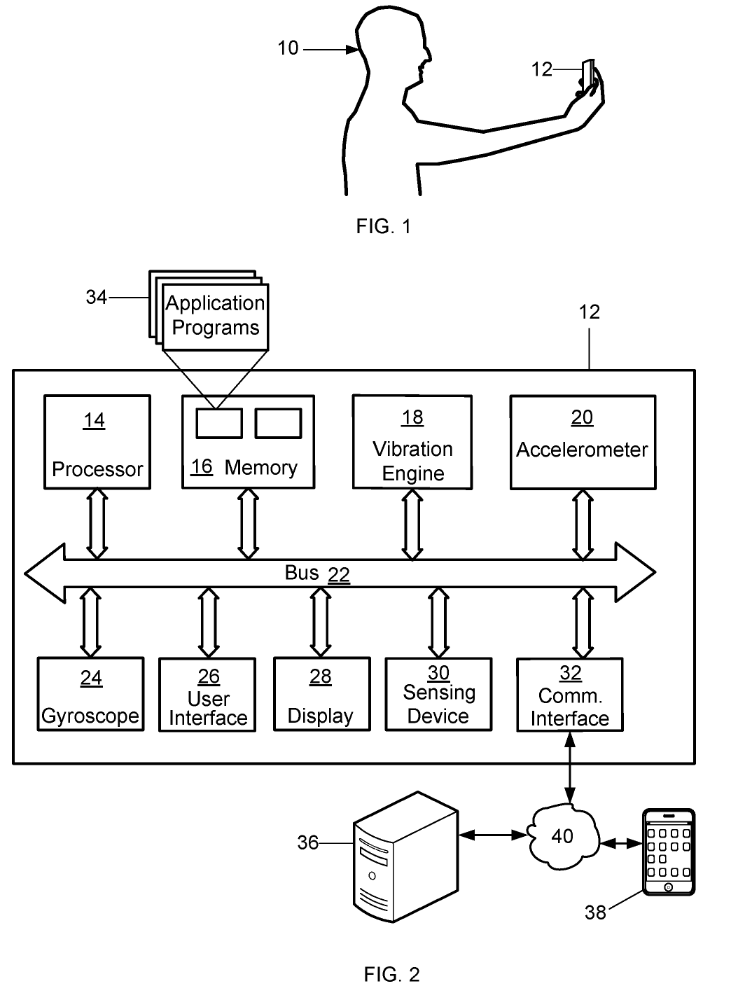

FIG. 1 is a side view of a person 10 holding and perhaps operating an example computing device 12. The person 10 holding the computing device 12 is referred to herein as a user.

FIG. 2 is a block diagram of the computing device 12 which may be used for capturing biometric data from users, verifying the identities of users, and determining user liveness. The computing device 12 includes one or more processors 14, a memory 16, a vibration engine 18, one or more accelerometers 20, a bus 22, a gyroscope 24, a user interface 26, a display 28, a sensing device 30, and a communications interface 32. General communication between the components in the computing device 12 is provided via the bus 22.

The computing device 12 may be any device or apparatus capable of at least vibrating, sensing movement and recording data for the movement, and performing the functions described herein. One example of the computing device 12 is a smart phone. Other examples of the computing device 12 include, but are not limited to, a cellular phone, a tablet computer, a phablet computer, a smartwatch, any type of portable device such as a personal digital assistant (PDA), and a vehicle steering system. Vehicle steering systems include a steering device and at least some of the components described herein as being included in the computing device 12. The steering device depends on the type of vehicle. For example, for automobiles the steering device is a steering wheel while for airplanes the steering device may be a control wheel, joystick or stick.

The processor 14 executes instructions, or computer programs, stored in the memory 16. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing the functions described herein. The above examples are exemplary only, and are thus not intended to limit in any way the definition and/or meaning of the term “processor.”

As used herein, the term “computer program” is intended to encompass an executable program that exists permanently or temporarily on any computer-readable recordable medium that causes the computing device 12 to perform at least the functions described herein. Application programs 34, also known as applications, are computer programs stored in the memory 16. Application programs 34 include, but are not limited to, an operating system, an Internet browser application, enrollment applications, authentication applications, and any special computer program that manages the relationship between application software and any suitable variety of hardware that helps to make-up a computer system or computing environment.

Authentication applications enable the computing device 12 to conduct authentication transactions which include verification and identification transactions (1:N), where “N” is a number of identity records in an authentication database. Verification transactions are the process of verifying the identity of a user. Typically, during a verification transaction biometric data is captured from a user and a template is created from the captured biometric data. The created biometric template is compared against a user record biometric template, and if the created and record templates match the identity of the user is verified as true.

The memory 16 may be any non-transitory computer-readable recording medium used to store data including, but not limited to, computer programs and user data records. The data record for each user may include raw biometric data, processed biometric data, biometric templates and personal data of the user. The raw biometric data is biometric data captured from a user and is processed to generate at least one biometric template. Biometric templates are typically used to conduct verification transactions; however, the raw biometric data may alternatively be used.

User personal data includes any demographic information including, but not limited to, name, gender, age, location, date-of-birth, address, citizenship and marital status. The data record, or records, are typically for a user that regularly operates, and is thus associated with, the computing device 12.

Configurable policies for determining which biometric data is to be stored in the data records and which is to be used for authentication transactions may also be stored in the memory 16. The biometric data used during authentication transactions may alternatively be determined by an individual or by any computer system 36 or computing device 38 configured to communicate with the computing device 12 over a network 40, or via Bluetooth, Radio Frequency Identification (RFID), Near Field Communications (NFC) or the like.

The biometric data may be for any biometric modality such as, but not limited to, voice, face, finger, iris, retina, palm, and electrocardiogram. Moreover, the biometric data may be user behavior or other data that reflects user behavior. Such user behaviors include, but are not limited to, how a user holds the computing device 12, how the user moves the computing device 12, how the user speaks into the computing device 12, how the user types on a keyboard that may be included in the computing device 12, and how the user moves while holding and perhaps operating the computing device 12. The biometric data may be for any biometric modality, any user behavior, or any combination of biometric modality and user behavior. The biometric modality data and user behavior data may take any form such as, but not limited to, vectors, matrices, multi-dimensional matrices and any other shaped data structure. Audio recordings take the form of vectors, photographs take the form of matrices, and videos take the form of multi-dimensional matrices.

Non-transitory computer-readable recording media may be any tangible computer-based device implemented in any method or technology for short-term and long-term storage of information or data. Moreover, the non-transitory computer-readable recording media may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like. Furthermore, the non-transitory computer-readable recording media may be implemented as smart cards, SIMs, any type of physical and/or virtual storage, or any other digital source such as a network or the Internet from which a computing device can read computer programs, applications or executable instructions.

The vibration engine 18 may be any type of motor or device capable of causing the computing device 12 to vibrate. For example, the vibration engine 18 may be an eccentric rotating mass vibrating motor or a linear resonant actuator. When the computing device 12 is a vehicle steering system, the steering device vibrates.

The accelerometer 20 and/or the gyroscope 24 detect movement of the computing device 12, generate data regarding the detected movement, and communicate the data to the processor 14. The data may also be communicated to the memory 16 via the bus 22. The processor 14 uses the generated data to determine the position and movement of the computing device 12.

The user interface 26 and the display 28 allow interaction between a user and the computing device 12. The display 28 may include a visual display or monitor that displays information to a user. For example, the display 28 may be a Liquid Crystal Display (LCD), active matrix display, plasma display, or cathode ray tube (CRT). The user interface 26 may include a keypad, a keyboard, a mouse, an infrared light source, a microphone, cameras, and/or speakers. Moreover, the user interface 26 and the display 28 may be integrated into a touch screen display. Accordingly, the display may also be used to show a graphical user interface, which can display various data and provide “forms” that include fields that allow for the entry of information by the user. Touching the screen at locations corresponding to the display of a graphical user interface allows the person to interact with the device 12 to enter data, change settings, control functions, etc. Consequently, when the touch screen is touched, the user interface 26 communicates this change to the processor 14, and settings can be changed or user entered information can be captured and stored in the memory 16.

The sensing device 30 may include RFID components or systems for receiving information from other devices. The sensing device 30 may additionally, or alternatively, include components with Bluetooth, NFC, infrared, or other similar capabilities. The computing device 12 may alternatively not include the sensing device 30.

The communications interface 32 provides the computing device 12 with two-way data communications. Moreover, the communications interface 32 enables the computing device 12 to conduct wireless communications such as cellular telephone calls and to wirelessly access the Internet over the network 40. By way of example, the communications interface 32 may be a local area network (LAN) card (e.g., for Ethemet™ or an Asynchronous Transfer Model (ATM) network) to provide a data communication connection to a compatible LAN. Further, the communications interface 32 may include peripheral interface devices, such as a Universal Serial Bus (USB) interface, a PCMCIA (Personal Computer Memory Card International Association) interface, and the like. Thus, it should be understood that the communications interface 32 may enable the computing device 12 to conduct any type of wireless or wired communications such as, but not limited to, accessing the Internet. Although the computing device 12 includes a single communications interface 32, the computing device 12 may alternatively include multiple communications interfaces 32.

The communications interface 32 also allows the exchange of information across the network 40. The exchange of information may involve the transmission of radio frequency (RF) signals through an antenna (not shown). Moreover, the exchange of information may be between the computing device 12 and between any other computer systems 36 and any other computing devices 38 capable of communicating over the network 40. The network 40 may be a 5G communications network. Alternatively, the network 40 may be any wireless network including, but not limited to, 5G, 4G, 3G, Wi-Fi, Global System for Mobile (GSM), Enhanced Data for GSM Evolution (EDGE), and any combination of a LAN, a wide area network (WAN) and the Internet. The network 40 may also be any type of wired network or a combination of wired and wireless networks.

Other computer systems 36 the computing device 12 may communicate with include computer systems of service providers such as, but not limited to, financial institutions, medical facilities, government agencies, authentication system operators, and merchants. Other computing devices 38 the computing device 12 may communicate with include, but are not limited to, smart phones, tablet computers, laptop computers, personal computers and cellular phones. The computing devices 38 may alternatively be referred to as computer systems or information systems, while the computer systems 36 may alternatively be referred to as computing devices or information systems.

Movement of the computing device 12 is caused by the sum of the forces acting on the computing device 12. Such forces include, but are not limited to, vibrations caused by the vibration engine 18 and forces exerted on the computing device 12 by the hand or other body part of the user. Additional or alternative forces may act on the computing device 12 when the computing device 12 is worn by a user or is pressed against a body part as part of a signature move practiced by a user.

When the forces acting on the computing device 12 are limited to the vibrations caused by the vibration engine 18 and the forces exerted on the computing device 12 by a body part of the user, the force exerted by the body part dampens the computing device vibrations. As a result, movement detected by the computing device 12 represents a damped version of the computing device vibrations. In the example methods described herein the body part is a hand of the user.

Different people hold computing devices 12 differently. Hand shape, hand size, grip strength, and area of contact are all factors that affect the dampening force applied to the computing device 12. Thus, the holding force exerted by each user on his or her computing device 12 is unique. As a result, when the computing device 12 vibrates, the vibrations are dampened differently for each user such that the dampened vibration is unique for each computing device-user combination. Consequently, the movement data captured by the computing device 12 reflects the effects of user behavior toward the computing device 12 and thus effectively constitutes data that may be used as a behavioral biometric to biometrically verify user identities and determine user liveness.

Each user may use the computing device 12 to capture movement data for a signature move, which data may also be stored in the data record of the user. Signature moves are unique user behaviors that cause dampening forces to be exerted on the computing device. For example, a signature move may be holding the computing device 12 with the right hand and resting the device 12 on the user's shoulder. Another example signature move may be firmly gripping an end of the computing device 12 with both hands while the device 12 is horizontal. Yet another example signature move may be horizontally suspending the computing device 12 with the left hand. Signature moves are secure because it is unlikely an imposter will know the signature move and because it is difficult to mimic signature moves. Consequently, movement data captured for signature moves is also biometric data that may be used to verify the identity of users.

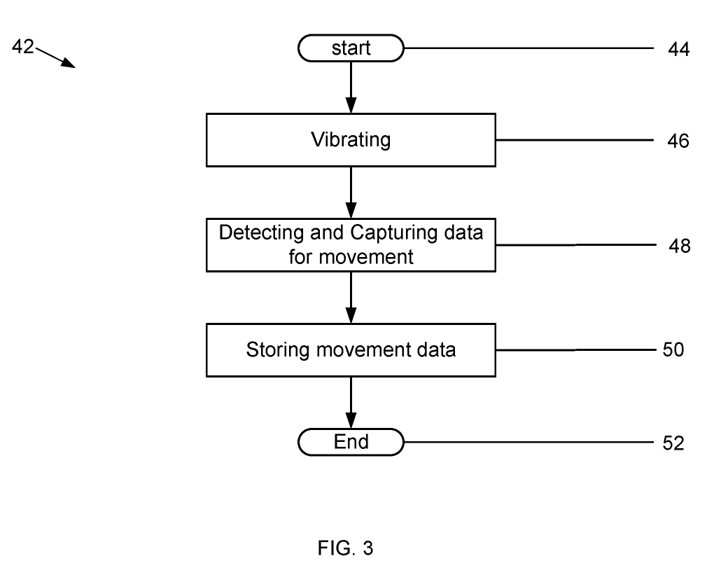

FIG. 3 is a flowchart 42 illustrating an example method for capturing biometric data from a user. A user may be required to prove his or her identity for many different reasons. A user may need to prove his or her identity to conduct a transaction using the computing device 12. Such transactions include, but are not limited to, unlocking the computing device 12, accessing an application stored in the computing device 12, starting or steering a vehicle, and conducting a network-based transaction. Network-based transactions include, but are not limited to, buying merchandise from a merchant website.

The method starts 44 when a user provides a claim of identity using the computing device 12. The user may provide the claim of identity in any manner, for example, by typing or speaking the claim of identity into the computing device 12 or selecting an identity from a list of identities. After the claim of identity is provided, the computing device 12 automatically starts vibrating 46 while the user holds and perhaps operates the computing device 12. The forces acting on the computing device 12 are limited to the vibrations caused by the vibration engine 18 and the forces caused by the user's hold. Movement 48 of the computing device 12 is detected and data 48 for the movement is captured by the computing device 12. The movement data is the dampened computing device vibration. The movement data is stored 50 in the memory 16. Next, processing ends 52.

Although the computing device 12 automatically vibrates in the example method, in alternative example methods the user may manually cause the computing device 12 to vibrate. For example, the user may press an icon or button, or otherwise input into the computing device 12 a command to vibrate.

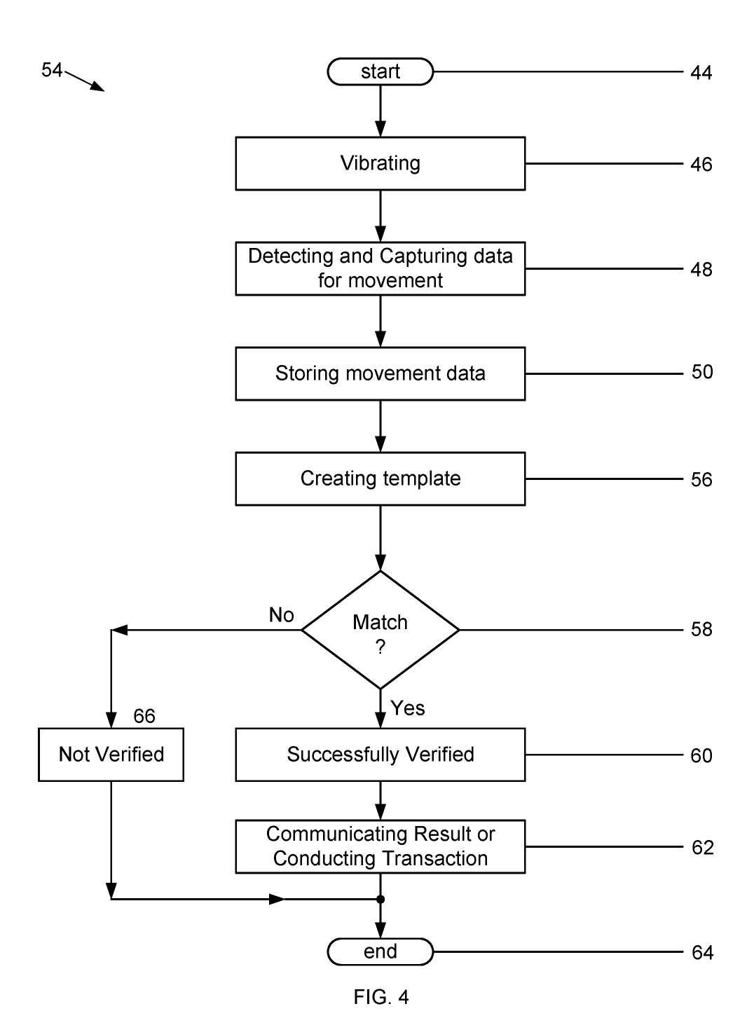

The information shown in FIG. 4 is similar to the information shown in FIG. 3 described in more detail below. As such, features illustrated in FIG. 4 that are identical to features illustrated in FIG. 3, are identified using the same reference numerals used in FIG. 3.

FIG. 4 is a flowchart 54 illustrating an example method for verifying the identity of a user. This example method includes the method steps shown in FIG. 3. Additionally, the movement data is processed into a template and is used to conduct a verification transaction. More specifically, after storing 50 the movement data the computing device 12 creates 56 a template from the movement data. Next, the computing device 12 matches 58 the created template against a record user template and calculates a matching score. If the matching score is equal to or greater than a threshold score, the templates are considered to match 58 and the user is successfully verified 60. Because a successful biometric verification transaction result can be generated from movement data unique to the user, a successful verification result necessarily indicates the movement data was also obtained from a live user, thus indicating the user is live. Alternatively, a template match may be used to determine user liveness only.

After the user is successfully verified 60, if the user is attempting to conduct a network-based transaction, a successful verification result is communicated 62 to a computer system operating a website on which the user desires to conduct the transaction and then processing ends 64. However, if the user is attempting to conduct another type of transaction, for example, accessing an application stored in the computing device 12, the user may be permitted to conduct the desired transaction. Next, processing ends 64.

When the matching score is less than the threshold score 58, the identity of the user is not verified 66, the user is not permitted to conduct the desired transaction, and processing ends 64. If the user is attempting to conduct a network-based transaction, an unsuccessful verification result may be communicated 68 to the computer system operating the website on which the user desires to conduct the transaction, and processing ends 64.

Although a claim of identity is provided in the example methods described herein, a claim of identity may not be provided in alternative example methods because one user is typically associated with the computing device 12. When a claim of identity is not necessary, the computing device 12 may automatically start vibrating when a user indicates a desire to conduct the transaction. Although the example methods described herein store the movement data in the computing device 12, alternative methods may temporarily store the movement data in the computing device 12 and discard the movement data after creating the template.

Although the movement data is for dampened computing device vibrations in the example methods described herein, in alternative example methods any movement data usable for verifying user identities may be used. Moreover, the movement data may be used with any other type of biometric data to conduct multi-modal biometric verification transactions.

The example methods described herein may be conducted entirely by the computing device 12, and partly by the computing device 12 and partly by any other computing devices 38 and computer systems 36 able to communicate with the computing device 12 over the network 40, Bluetooth, RFID, NFC, or the like. Moreover, data described herein as being stored in the computing device 12 may alternatively be stored in any computer system 36 or computing device 38 configured to communicate with the computing device 12 over the network 40, Bluetooth, RFID, NFC, or the like.

In each example embodiment, the above-described methods and systems for capturing biometric data from users and verifying user identities enhance user convenience during verification transactions, enhance the trust in verification transaction results, and facilitate reducing the cost of conducting network-based transactions for merchants and other entities conducting network-based operations. More specifically, a computing device vibrates while a user holds and perhaps operates the computing device. The computing device captures movement data resulting from at least the vibrations and the user's holding behavior, and creates a template from the movement data. The template is matched against a record user template and a matching score is calculated. If the matching score is equal to or greater than a threshold score, the identity of the user is verified and the user is determined to be live. As a result, the trustworthiness of biometric verification transaction results is enhanced, user convenience is enhanced, and costs incurred by users and merchants due to successful spoofing and faulty verification transaction results are facilitated to be reduced.

The example methods and systems for capturing biometric data and verifying user identities described above should not be considered to imply a fixed order for performing the method steps. Rather, the method steps may be performed in any order that is practicable, including simultaneous performance of at least some steps. Moreover, the method steps may be performed in real time or in near real time. Furthermore, the invention is not limited to the embodiments of the methods and systems described above in detail. Rather, other variations of the methods and systems may be utilized within the spirit and scope of the claims.

What is claimed is:

1. A method for capturing biometric data comprising:
causing, by a vibration engine included in a computing device, the computing device to vibrate;
detecting, by the computing device, movement of the computing device, the movement representing dampened computing device vibrations; and
capturing, by the computing device, data regarding the movement.

2. A method for capturing biometric data in accordance with claim 1 further comprising conducting a verification transaction with the movement data.

3. A method for capturing biometric data in accordance with claim 1, further comprising creating a template from the movement data.

4. A method for capturing biometric data in accordance with claim 3, further comprising:
matching the created template against a record user template;
calculating a matching score based on the match; and
verifying the identity of the user when the matching score is at least equal to a threshold score.

5. A method for capturing biometric data in accordance with claim 4, further comprising determining the user is live when the matching score is at least equal to the threshold score.

6. A computing device for capturing biometric data comprising:
a processor; and
a memory configured to store data, said computing device being associated with a network and said memory being in communication with said processor and having instructions stored thereon which, when executed by said processor, cause said computing device to:
vibrate;
detect movement of the computing device, the movement representing dampened computing device vibrations; and
capture data regarding the movement.

7. A computing device in accordance with claim 6, wherein the instructions when executed by said processor further cause said computing device to conduct a verification transaction using the movement data.

8. A computing device in accordance with claim 7, wherein the instructions when executed by said processor further cause said computing device to create a template from the movement data.

9. A computing device in accordance with claim 8, wherein the instructions when executed by said processor further cause said computing device to:
match the created template against a record user template;
calculate a matching score based on the match; and
verify the identity of the user when the matching score is at least equal to a threshold score.

10. A computing device in accordance with claim 9, wherein the instructions when executed by said processor further cause said computing device to determine the user is live when the matching score is at least equal to the threshold score.

11. A method for determining user liveness comprising:
causing, by a vibration engine included in a computing device, the computing device to vibrate;
detecting, by the computing device, dampened computing device vibrations;
creating a biometric template from the dampened vibrations;
matching the created template against a corresponding user record template;
calculating a matching score based on the match; and
determining, by the computing device, the user is live when the matching score is at least equal to a threshold score.
